(19) United States
(12) Patent Application Publication
(10) Pub. No.: US 2016/0124548 A1
(43) Pub. Date: May 5, 2016

(54) MATERIALS AND STRUCTURES FOR HAPTIC DISPLAYS WITH SIMULTANEOUS SENSING AND ACTUATION

(71) Applicant: Northwestern University, Evanston, IL (US)

(72) Inventors: Mondher CHERIF, Evanston, IL (US); James E. COLGATE, Evanston, IL (US); Michael A. PESHKIN, Evanston, IL (US); Michael F.D. OLLEY, Lake Zurich, IL (US); Gregory TOPEL, Oak Park, IL (US)

(21) Appl. No.: 14/931,209

(22) Filed: Nov. 3, 2015

Related U.S. Application Data
(60) Provisional application No. 62/074,362, filed on Nov. 3, 2014.

(51) Int. Cl. G06F 3/044; G06F 3/01; B05D 7/00; G06F 3/041

(52) U.S. Cl. CPC G06F 3/044; G06F 3/0412; G06F 3/016; B05D 7/58; G06F 2203/04103

(57) ABSTRACT

A haptic interface device, said device comprising a substrate, a first conducting layer deposited on the substrate, with the first conducting layer being patterned to provide a first axis of individually-addressable conductive electrodes, a first insulating layer deposited on the first conducting layer, with the insulating layer having a uniform thickness, a second conducting layer deposited on the first insulating layer, with the second conducting layer being patterned to provide a second axis of individually-addressable conductive electrodes, and a dielectric layer deposited on the second conducting layer, with the dielectric layer having a uniform thickness and hardness and being scratch resistant.

### CROSS-REFERENCE TO RELATED APPLICATIONS

This application is a non-provisional patent application that claims the benefit of and the priority from U.S. Provisional Patent Application No. 62/074,362, filed Nov. 3, 2014, titled MATERIALS AND STRUCTURES FOR HAPTIC DISPLAYS WITH SIMULTANEOUS SENSING AND ACTUATION.

### STATEMENT REGARDING FEDERALLY SPONSORED RESEARCH OR DEVELOPMENT

This invention was made with government support under grant number IIP-1330966 awarded by the National Science Foundation. The government has certain rights in the invention.

### BACKGROUND OF THE INVENTION

The present disclosure generally relates to touch interface devices and more particularly to constructions and methods of construction for touch surfaces of such devices that provide touch sensing input and haptic output.

Touch interfaces can be found in laptop computers, gaming devices, automobile dashboards, kiosks, operating rooms, factories, automatic tellers, and a host of portable devices such as cameras, tablets, and phones. Touch interfaces provide flexible interaction possibilities that discrete mechanical controls do not. But today's touch interfaces sacrifice an important part of the human experience: haptics. “Haptics” refers to the perceptual system associated with touch. Haptics lets us touch type, find a light switch in the dark, wield a knife and fork, enjoy petting a dog or holding our spouse's hand. Haptics is not just about moving one's hands, but it is about feeling things, recognizing objects (even without looking at them), and controlling the way that we interact with the world.

Recently, electrostatic actuation has been developed as a means for creating haptic effects localized to the fingertip. For instance, in a previous patent application (U.S. patent application Ser. No. 13/468,818, entitled Electrostatic Multi-touch Haptic Display), a number of ways of achieving multi-point electrostatic haptics are described. In another recent patent application (U.S. patent application Ser. No. 14/306,842, entitled Haptic Display with Simultaneous Sensing and Actuation), a number of ways of arranging electrodes to enable both multitouch sensing and multi-point electrostatic haptics are described. The basis of electrostatic haptics is the modulation of frictional force via an electric field. The electric field is established at the point of contact between the fingertip and the touch surface. This is accomplished by placing one or more electrodes on the touch surface of the substrate and insulating those electrodes from the fingertip with a dielectric layer.

To set up such an electric field, a circuit must be closed through the finger. There are two principal ways of doing this. Others have taught the method shown in FIG. 1a, in which the capacitance of the finger-dielectric-electrode system is part of a circuit that is closed through a second contact at some other part of the body. In this prior art, an electric circuit is closed between two separate contact locations. For instance, in FIG. 1a, which is from a Senseg patent, the two locations are both shown as fingertips. We have taught in prior patent applications the method shown in FIG. 1b, in which two separate electrodes are placed under a single contact location, and the circuit is therefore closed through a single fingertip itself, not involving the rest of the body. It should be noted (and this will be important for the present invention) that the dielectric layer is preferably quite thin, such as 0.1-50 microns. A thin dielectric layer allows a large electric field to be produced without extremely high voltages.

In order to apply the two-electrode and single fingertip technique, it is necessary to create a suitable array of electrode pairs on the touch surface. One approach is to use a lattice of electrodes. An illustrative embodiment is shown in FIG. 2, although many other lattice and non-lattice structures are possible. FIG. 2 shows a diagram of a lattice of “diamond-shaped” electrodes which may be used to provide both sensing and haptics over a touch surface. Shown are both an x-axis (horizontal electrodes) and a y-axis (vertical electrodes). The electrodes normally would be covered by an insulating layer as is shown above the two electrodes in FIG. 1b. This arrangement also allows the haptic effects to be localized. In the case shown in FIG. 2, the y electrode labeled ‘+’ is brought to a positive voltage while the x electrode labeled ‘−’ is brought to a negative voltage (relative to device or earth ground). The haptic effect is concentrated at the intersection of the two electrodes. Each electrode may be characterized by a length, a width, and a shape (in this case, repeating diamonds). Also of importance is the length scale over which electrodes repeat, referred to as the pitch. Lattice structures have many advantages for sensing known in the art, and we have previously shown that they also have advantages for haptics. For example, they support multi-point haptics by allowing effects to be localized near electrode intersections.

Lattice patterns, however, also pose certain challenges. One challenge is clearly illustrated in FIG. 2: the electrodes on one axis must cross over those on each additional axis. For the purposes of touch sensor construction, a number of techniques have been developed for handling crossovers. For example, given two axes of electrodes, each axis can be deposited and patterned on a single side of a substrate. Often, the substrate is polyester and the electrodes are Indium Tin Oxide (ITO), for transparency. Alternatively, both axes can be deposited and patterned on the same side of a substrate (which may, for instance, be glass), leaving the diamond-shaped segments isolated from one another on one of the axes. These segments can then be connected via “bridges.” Bridge manufacture involves two more steps: first, insulator patches must be deposited at the location of each bridge; second, the bridge itself is deposited on top of the insulator and makes connection to two segments. In a typical construction, the insulator is a transparent polymer and is much thicker than the conductive bridges and electrodes (1.8 microns versus 50 nanometers).

While both the two-sided and bridge construction techniques are suitable for conventional touch sensors, both techniques have certain shortcomings when applied to electrostatic haptics. For example, in electrostatic haptics, both electrode axes are ideally quite close to the user's skin at the point of touch, separated only by an insulator that may be about 1 micron thick. However, the two-sided technique requires that one of the axes of electrodes is separated from the skin by at least the thickness of the substrate, which normally is more than 100 microns. The bridge technique allows all of the electrodes to be closer, but results in protuberances due to the insulators at the locations of the bridges, and those protuberances are subject to wear and breakdown.

Conventional touch screen manufacture poses other difficulties for electrostatic haptics as well. For example, electrodes for sensing generally are placed underneath a protective cover glass that is at least one millimeter thick. This thickness makes it difficult to establish large enough electrostatic fields for haptics without using impracticably high voltages.

### BRIEF SUMMARY OF THE INVENTION

One embodiment of the present disclosure includes a haptic interface device comprising a substrate, a first conducting layer deposited on the substrate, with the first conducting layer being patterned to provide a first axis of individually-addressable conductive electrodes, a first insulating layer deposited on the first conducting layer, with the insulating layer having a uniform thickness, a second conducting layer deposited on the first insulating layer, with the second conducting layer being patterned to provide a second axis of individually-addressable conductive electrodes, and a dielectric layer deposited on the second conducting layer, with the dielectric layer having a uniform thickness and hardness and being scratch resistant.

In another embodiment, the insulating layer is deposited across the entire surface of the first conductive layer such that the surface of the insulating layer is planar with no protrusions.

In another embodiment, the dielectric coating layer is deposited at a temperature of at least 170 C, and the substrate, the conductive layers and the insulating layer are capable of withstanding a temperature of at least 170 C without degradation.

In another embodiment, the dielectric layer further comprises alternating layers of organic and inorganic materials.

In another embodiment, the insulating layer is made of silica (SiO₂).

In another embodiment, the dielectric layer is at least 1 micron thick.

In another embodiment, the dielectric layer is no more than 50 microns thick.

In another embodiment, the substrate, the conductive layers, the insulating layer, and the dielectric layer are transparent.

In another embodiment, signals for touch sensing are obtained from capacitance of each electrode, and wherein haptic effects are produced by generating an electric field between an electrode and an appendage of a user that touches a touch surface of the device.

In another embodiment, an index matching layer is provided underneath the first conductive layer.

Another embodiment of the present disclosure includes a method of forming a haptic device, the method including the steps of forming a substrate, depositing a first conductive layer on the substrate, patterning electrodes into the first conductive layer, depositing an insulation layer on the first conductive layer, depositing a second conductive layer on the insulation layer, patterning electrodes into the second conductive layers, and depositing a dielectric layer on the second conductive layer.

In another embodiment, the insulating layer is deposited across the entire surface of the first conductive layer such that the surface of the insulating layer is planar with no protrusions.

In another embodiment, the insulating layer is made of silica (SiO2).

In another embodiment, the dielectric layer is deposited at a temperature of at least 170 C, and the substrate, the conductive layers and the insulating layer are capable of withstanding a temperature of at least 170 C without degradation.

In another embodiment, the dielectric layer further comprises alternating layers of organic and inorganic materials.

In another embodiment, the dielectric layer is at least 1 micron thick.

In another embodiment, the dielectric layer is no more than 50 microns thick.

In another embodiment, the substrate, the conductive layers, the insulating layer, and the dielectric layer are transparent.

In another embodiment, signals for touch sensing are obtained from capacitance of each electrode, and wherein haptic effects are produced by generating an electric field between an electrode and an appendage of a user that touches a touch surface of the device.

In another embodiment, an index matching layer is provided underneath the first conductive layer.

### BRIEF DESCRIPTION OF THE SEVERAL VIEWS OF THE DRAWING

FIG. 1A depicts a schematic of an electric circuit from a prior art touch interface using two electrodes and in which the electric circuit is closed by user contact at two separate locations;

FIG. 1B depicts a schematic of an electric circuit from a touch interface using two electrodes that are placed under a single user contact location for closing the electric circuit by user contact at a single location;

FIG. 2 depicts a schematic showing a lattice of diamond-shaped electrodes;

FIG. 3 depicts a schematic showing a simplified cross-section of functional layers of a touch interface that includes layers of electrodes to permit simultaneous touch sensing and haptic actuation;

FIG. 4 depicts a schematic representation of a flow diagram showing steps of a method used to apply coatings for a single cell, such as a single touch panel, in the course of making a touch interface device;

FIG. 5 depicts a schematic showing a simplified view of a Coulomb type device for electrostatic attraction using an insulating layer in a touch interface, and a simplified view of a Johnsen-Rahbek type device where the insulating layer has semiconducting properties in a touch interface;

FIG. 6 depicts a schematic showing a lattice that preserves the symmetry of the diamond pattern, but increases overlap of adjacent rows or columns by using an alternative electrode shape having a greater width than pitch;

FIG. 7 depicts a schematic showing a lattice that combines a finer pitch on one axis, and overlap on a second axis, where the electrodes on the respective axes are of a different shape that permits much greater overlap on one axis;

FIG. 8 depicts a schematic showing a lattice with alternative shapes to those shown in FIG. 7, but achieving a similar result of providing much greater overlap on one axis;

FIG. 9 depicts a schematic showing a simplified view of an electrode pattern in which no electrode crosses over another electrode and in which the pattern includes two separate blocks having independent sets of electrodes;

FIG. 10 depicts a schematic an electrode design in which the areal density is a function of location along the length of the electrode; and

FIG. 11 depicts a schematic showing a simplified view of an electrode pattern wherein the layers of electrodes are separated by an insulator and in which more intersections are introduced to create greater overlap.

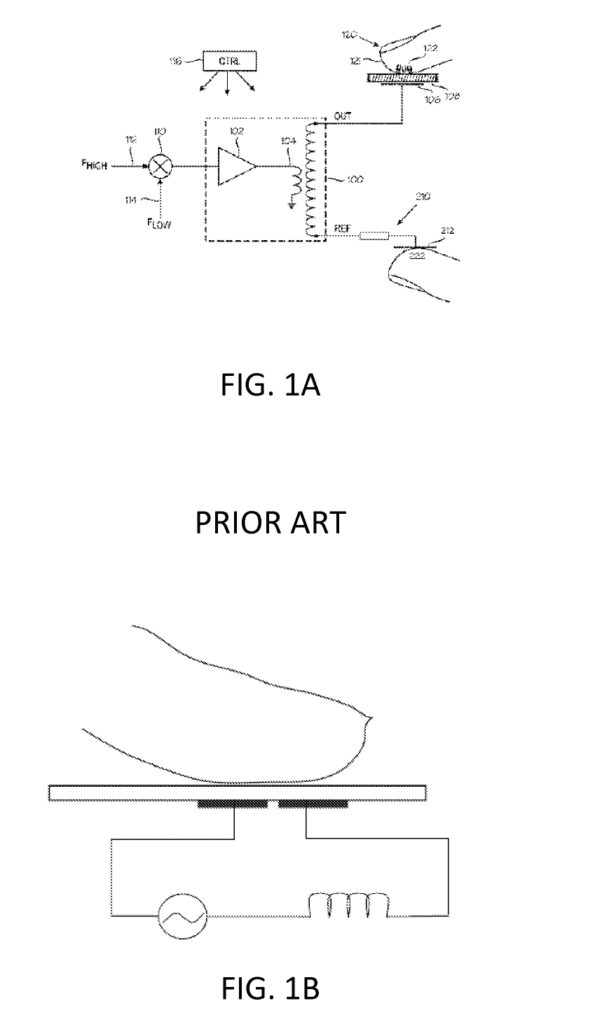

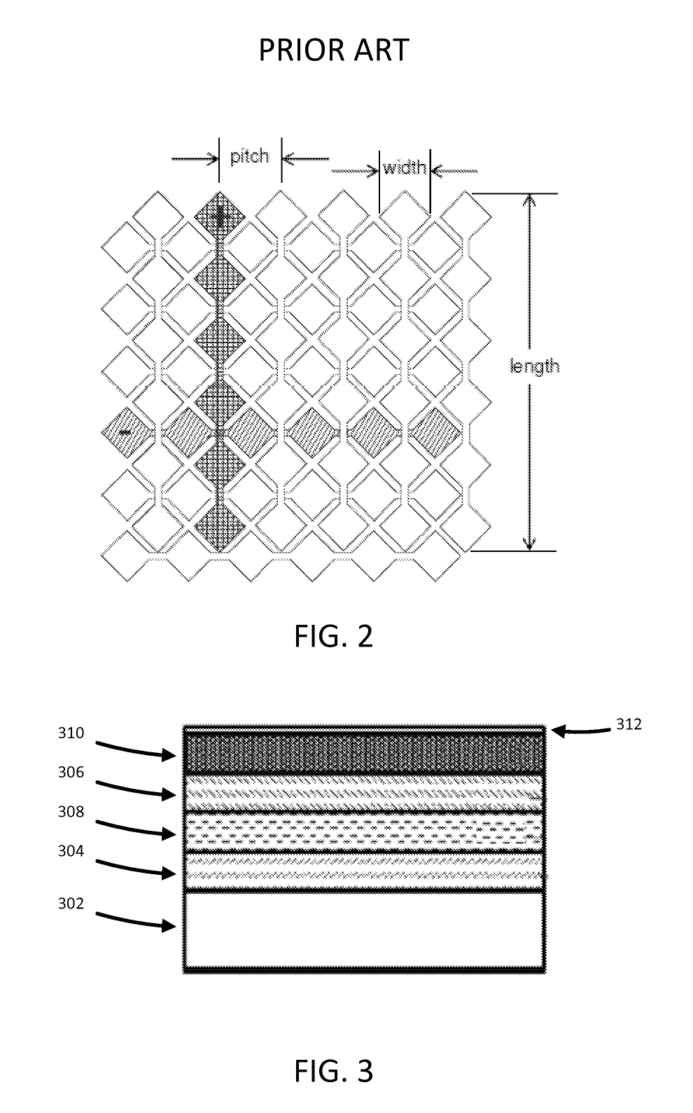

It should be understood that the drawings are not to scale. While some details of a touch interface device have not been included, such details are considered well within the comprehension of those of skill in the art in light of the present disclosure. It also should be understood that the present invention is not limited to the example embodiments illustrated.

### DETAILED DESCRIPTION OF THE INVENTION

Within the teachings of this disclosure, a touch interface providing simultaneous touch sensing and haptic actuation is manufactured by depositing and patterning a series of layers on the front (touch) surface of an insulating substrate. The substrate may be either a rigid material, such as glass, or a flexible material, such as plastic. A first conductive layer, comprising a conductive material, may serve as a first axis of electrodes (for example, an x axis if there are two axes). An insulating layer, comprising an insulating material, may serve as an insulator and may be either patterned to form individual insulator patches at each desired x-y intersection (bridges) or applied as a full continuous sheet. A second conductive layer, comprising a conducting material, may serve as a second axis of electrodes (for example, a y axis if there are two axes). Additional alternating insulating and conducting layers may be provided for additional electrodes. After all electrode layers are complete, an optional passivation layer may be provided to protect the outermost electrode layer, before additional processing. Applied on top of the last electrode layer or the passivation layer is a protective hard dielectric coating layer that protects the underlying electrodes and prevents direct contact of any electrodes with the skin of the touchscreen user. Further additional layers, known in the art, may be provided below, within or on top of the dielectric coating layer for anti-reflection, anti-glare, anti-bacterial, and hydrophobic and oleophobic properties.

Conductive traces may be used to convey electrical signals from the electrodes to locations near the edge of the substrate where connection may be made to electronic components. An optional transparent or opaque border can be added to cover the traces and/or electronic components connected thereto. Electrical connection to the traces can be made on the front surface of the substrate or the traces can be conveyed to the rear surface where electrical connection can be made instead.

FIG. 3 provides a diagram that represents a simplified cross-sectional view of functional layers for a representative embodiment of the invention, although the vertical axis is not to scale. A substrate 302 is formed with a first conductive layer 304 formed on the substrate 302. A second conductive layer 306 is formed with an insulating layer 308 between the first conductive layer 304 and the second conductive layer 306. A hard dielectric layer 310 is formed on the second conductive layer 306 and an anti-smudge layer 312 is formed on the hard dielectric layer 310. In another embodiment, the first conductive layer 304 and second conductive layer 306 may be 50 nanometers of Indium Tin Oxide (ITO). In one embodiment, the first and second conductive layers 304 and 306 are formed into separate electrode lattices. In another embodiment, the electrodes in each lattice are diamond shaped.

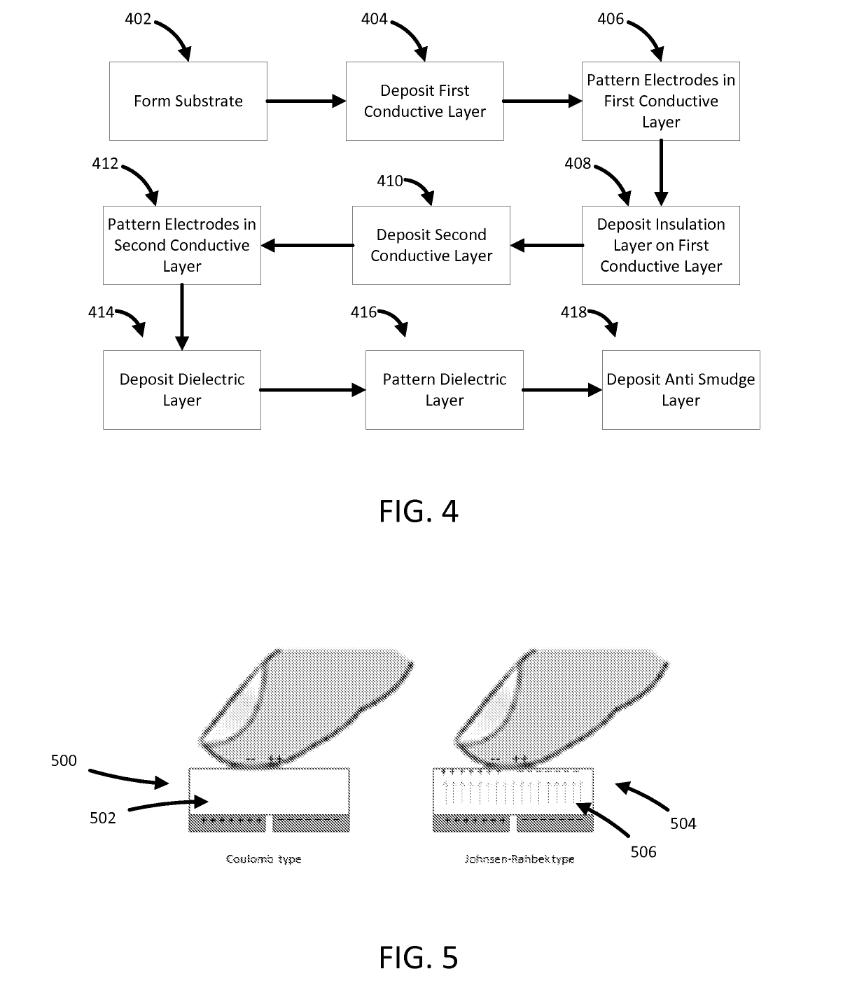

FIG. 4 shows a flow diagram of a method to apply coatings to a single cell (e.g., a single touch panel), while making a touch interface device. In step 402, the substrate 302 is formed. In one embodiment, the substrate 302 may be a 1 millimeter thick sheet of chemically strengthened glass with optional beveled edge(s). In step 404, the first conductive layer 304 is deposited on the substrate 302 via sputtering. In step 406, electrodes are patterned into the first conductive layer 304 using photolithography and wet etching. In step 408, the insulation layer 308 is deposited on the first conductive layer 304 via sputtering and patterned via photolithography and dry etching. In one embodiment, the insulating layer 308 is 300 nanometers thick and covers substantially the entire surface (not just the intersections) of the first conductive layer 302, so that the surface remains substantially planar, without protrusions that may be subject to wear. In one embodiment, the insulating layer 308 may be silica (SiO2). By using SiO2, rather than a conventional bridge insulation polymer, the insulating layer 308 can withstand higher processing temperatures, enabling the final hard coating to be deposited or cured at an elevated temperature. This is of great importance in achieving the greatest hardness possible. Alternatively, the insulating layer 308 may be silicon nitride (Si3O4) or any of a number of inorganic insulating materials that, like silica, can withstand higher processing temperatures. As yet another alternative, the insulating layer 308 may itself be made of multiple layers, such as a layer of silica and a layer of silicon nitride.

In step 410, the second conductive layer 306 is deposited on the insulation layer 308 via sputtering. In step 412, electrodes are patterned into the first conductive layer 304 using photolithography and wet etching. In step 414, the dielectric layer 310 is formed on the second conductive layer 306 via sputtering. In a one embodiment, the hard dielectric layer 310 is 2 microns of alumina (Al2O3), deposited by sputtering at 170 C or higher. Consistent with this embodiment, the alumina coating is more abrasion and scratch resistant than chemically strengthened glass so that it protects the underlying electrodes. In step 416, the dielectric layer is patterned with photolithography and dry etching or the use of a shadow mask.

It will be appreciated that alternative materials and thicknesses may be used, such that, more generally, the novel haptic touch screen construction includes a multiplicity of layers of conductive electrodes separated by insulation layers and covered by a protective hard dielectric overcoat or coating layer. Conductive traces are used to connect electrodes to electronic components located at one or multiple sides of the device, and an optional transparent or opaque border can be added to cover the traces. Electrode patterns that are known in the art (e.g. diamond, bands, blocks), as well as novel patterns that will be discussed below, may be suitable. The insulated layers can be patterned to form individual insulation where electrodes from a given layer cross over electrodes on other layers, or could be laid down or applied as a full continuous sheet, completely separating one layer from the next. When using the full sheet insulation, one can realize a planar surface that is more robust than the one obtained when using bridges or similar constructions that produce protruding features. Advantageously, the devices can be manufactured in sheet form and cut into separate cells at intermediate steps or at the end of the process, or manufactured in individual/single cell form from the start of the process.

The most widely used material for transparent conductive electrodes is indium tin oxide (ITO); however alternative materials such as AZO, graphene, metal nanowires, metal mesh, PEDOT, carbon nanotubes, etc. can be used. Typical thicknesses for ITO electrodes are 10 nm-80 nm, but can be thinner or thicker as necessary to adjust, for example, optical and electrical properties.

The insulation layers can be organic or an inorganic material and preferably are constructed of a material that can withstand high temperature (>150 C), such as silicon oxide, silicon nitride, silicon oxynitride, Niobium oxide, etc. The thickness of the insulating material to be used will depend on its breakdown voltage and desired optical properties. In the case of SiO2, a thickness range of 10 nm-1000 nm is suitable.

The protective dielectric coating layer also may be a polymer or a ceramic material and preferably has a high dielectric constant. For instance, a dielectric constant of 10 or greater may be desired. Barium titanate, lead strontium titanate, lithium niobate, PLZT, PZT, polyimide, PVDF, parylene, Hafnium oxide, silicon oxide, titanium oxide, niobium oxide, tantalum oxide, aluminum oxide, ceramic embedded polymers, and DLC, are examples of the materials that can be used as the dielectric coating layer. The dielectric coating layer thickness and material choice can be optimized for functionality and optical properties and one dielectric or a multilayer dielectric stack including two or more layers can be used. For instance, the dielectric coating layer itself may comprise alternating layers of organic and inorganic dielectric materials. A typical thickness of the stack or coating is in the range of 0.1 um-25 um, but it may be thinner or thicker.

The protective dielectric layer preferably is quite durable and adheres well to the underlayer. For instance, it should not be susceptible to easily being abraded or scratched. Preferably, the coating exhibits an abrasion resistance similar to that of glass or better, and a Mohs hardness of greater than 6. The layer also should resist cracking and delamination. A novel approach is to use alternating layers of soft and hard materials with the hard materials being the outer layer (touch surface).

The touch surface also may be enhanced by applying one or more of the following type of coatings: hydrophobic, oleophobic, moisture barrier, anti-fouling, anti-abrasion, anti-scratch, and/or low coefficient of friction coatings.

The thickness of the layers and choice of materials may be designed in a way to optimize functionality (sensing, haptic output, and durability) and optical properties. For example, all the layers' materials and thicknesses may be chosen in order to minimize the light reflection (AR construction). In some cases, index matching or anti-reflection layers may be deposited under the ITO film in order to achieve the best optical properties (reflection and color) in an effort to render the ITO patterning not visible from above the touch surface. Material and process compatibility also may dictate the device structure. For example, in order to obtain a very durable Al2O3 coating, high temperature processing is required and hence organic insulators cannot be used (because they would be damaged by the temperature) and instead, SiO2 may be chosen as the insulator.

The haptic output may be enhanced without requiring an increase in the driving signal, such as by having a surface that exhibits a low coefficient of friction to the sliding touch in the off state, which will increase the friction difference between the on and the off states. Obtaining a low coefficient of friction surface can be accomplished in many ways, including for instance: a) providing a textured substrate, such as an etched substrate and preferably having a fine etch that is tailored for use with high resolution displays, i.e., does not result in glitter when used with the display; b) using a matte/anti-glare coating, and similar to an etched substrate the matte coating preferably is tailored for use with high resolution displays; c) adding nano-particles to the liquid solution in the case of using a solgel manufacturing process; or d) using nanostructured features/coatings, in this case such as using self-assembled microstructure or micro-fabricating the desired features on the surface of the device.

Electrical connection can be made to the front surface following standard touch screen practices, such as flexible cable adhered with anisotropic conductive film. However, for a flush mount application the electrical connections would be made to the back surface. In this case the signal is conveyed to the back surface using one of the following methods: a) throughways or apertures that are drilled or stamped out (in the case of a plastic substrate), as throughways or apertures can be filled with a conductive material in the form of ink/paste or pins, and the throughways or apertures may be used to transfer the signal traces to the back side of the substrate where a cable will be attached; b) grooves, wherein similar to throughways or apertures, grooves may be made and filled with conductive material; c) a beveled edge, such that in a case where the thickness of the substrate makes it feasible, a beveled edge may be used and the signal traces may be carried out to the beveled edge where they are attached to a cable; and/or d) in the case of a flexible substrate the device dimension can be made larger than the actual touch screen area and then the traces may be extended to the extra space. The substrate then may be bent over the display and the cable connection may be located at the back or side of the display, and there may be no need to connect to the back of the surface of the touch screen.

The described haptic enabled touch screen can be constructed on rigid transparent substrates, such as glass, sapphire, PMMA, cyclo olefin copolymer, polycarbonate, and cyclo olefin polymer as well as opaque substrates such as ceramics and plastics. Furthermore, the device may be constructed on flexible substrates using the same materials and processes that are used in the manufacturing of flexible displays and touch screens. For example, ITO is not a suitable transparent electrode for flexible devices. Instead, Graphene, metal nanowires, and PEDOT may be used. In the case of opaque applications, the choice of substrate, electrode, dielectric, traces, and insulation materials is much wider than the case when the application requires a transparent device. For example, the electrodes could be the same metal material as the traces.

The discussion thus far has included only the coulomb type electrostatic attraction, where an insulating dielectric coating layer is used. However, another configuration can be used to construct the electrostatic haptic device that uses the Johnsen-Rahbek effect. Johnsen-Rahbek electrostatic devices have a similar construction as the coulomb type device, discussed above, except for the dielectric coating layer. A semiconducting dielectric with volume resistivity between 10̂9 and 10̂13 Ωcm is used instead of the insulating dielectric. The Johnsen-Rahbek device results in stronger haptic effects than those obtained by the coulomb device using the same applied voltage and the same thickness of the dielectric. Aluminum nitride, boron nitride, and doped aluminum oxide are examples of materials that can be used as the semiconducting dielectric in the Johnsen-Rahbek type device.

FIG. 5 provides a diagram showing a simplified view of a Coulomb type device 500, wherein the insulating layer 502 has very high resistivity, and all coupling from the electrodes to the finger is capacitive, as well as a diagram showing a simplified view of a Johnsen-Rahbek 504 type of device, wherein the insulating layer 506 has semiconducting properties allowing free charge to move to the insulator surface, direct conduction to the finger is limited by contact resistance, thereby allowing a thicker insulating layer to be used. In one embodiment, the dielectric layer 310 has semiconducting properties that allow free charge to move towards the anti-smudge layer increasing the electrical force applied to a finger at the surface. Another way to allow for a relatively thicker protective coating construction without increasing the required voltages is to have alternating layers of conductive electrodes and dielectric film in a coating layer with the signal being connected to the first (deepest) set of electrodes.

As mentioned above, many different electrode patterns may be used with the construction methods taught herein. Although well-known patterns, such as diamonds, may be used, these patterns have some disadvantages in the context of combined haptics and sensing. With the methods taught, herein, the electrodes are much closer to the touch surface than is ordinarily the case for a touch sensor. Because of this, the capacitive coupling to electrodes that are immediately underneath the finger is much stronger than the capacitive coupling to electrodes that are nearby, but not immediately underneath the finger. As such, the signals obtained for sensing finger location tend to be more “focused” on the electrodes immediately underneath the finger and less “blurred” than would be the case for typical projected capacitance sensing.

If the electrode pattern is not modified relative to a design for projected capacitance, then fewer electrodes may provide useful signal and it may be more difficult to compute a precise finger location via interpolation. One solution to this difficulty is simply to have more electrodes (i.e., a finer pitch of electrodes), so that more signal is obtained. This approach, however, requires proportionally more connections and electronics, and is therefore more expensive. Another approach is to spread the finger signal at the touch surface by using a high resistivity outer shell. The outer shell could be made by adding a low density of well-dispersed conductive nano-particles to the outer-most layer. An example would be adding silver nanoparticles that also would act as an anti-bacterial layer.

Another approach is to use an unconventional electrode layout in which there is a greater amount of overlap between adjacent rows. We should note that the term “overlap” sometimes refers to a situation in which a portion of an electrode on one axis occludes a portion of an electrode on a second axis, when viewed from a direction normal to a plane containing the two axes. For our purposes, this is not desirable because it creates parasitic capacitance. We use the term “overlap” to instead refer to a situation such as nesting, in which a portion of one electrode fits into a cut-out space from a neighboring electrode, without occlusion. One key property of such overlapping electrodes is that the width of individual electrodes is greater than the pitch of the set of electrodes. Such a layout would, in effect, cause a form of blurring of the signals from adjacent electrodes.

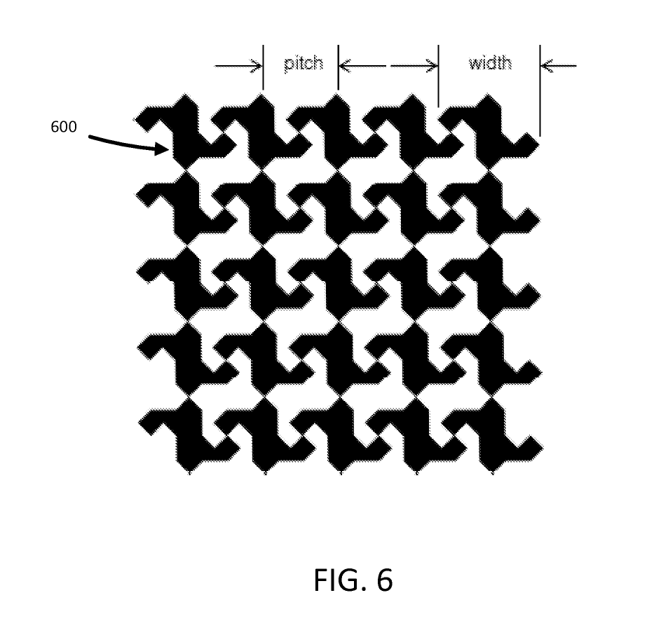

FIG. 6 provides a diagram showing an example of such a pattern in which the electrode width is greater than the pitch, and is greater than it would be for a diamond pattern having the same pitch. The electrodes 600 are arranged in a lattice pattern, with a portion of each electrode 600 occupying space typically occupied by an adjacent electrode 600. Although there are many ways to generate such patterns, one basic strategy is to start with a diamond pattern and to morph it by twisting and/or stretching the lines at the points where the two axes meet but do not overlap. As shown in FIG. 6, this strategy preserves the symmetry of the original diamond pattern while increasing the overlap of adjacent rows or columns.

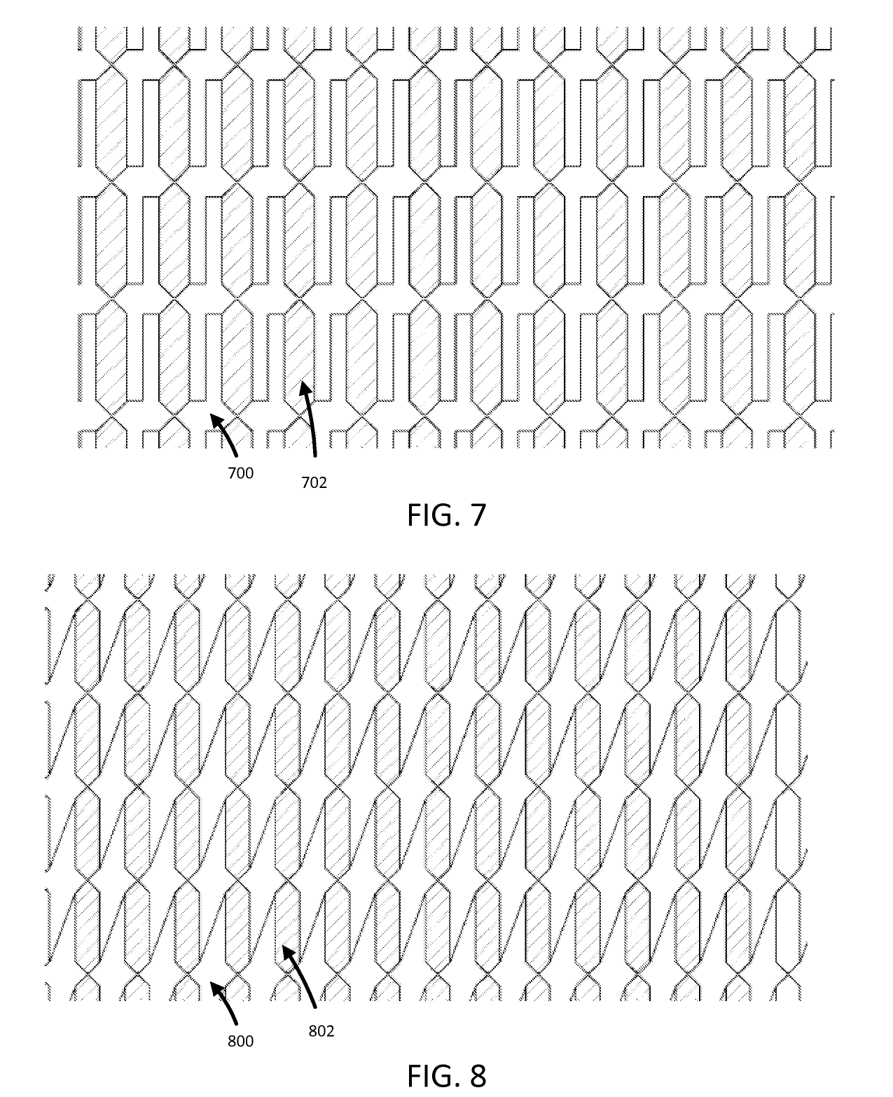

Yet another approach is to combine finer pitch on one axis, and overlap on a second axis. This strategy does not preserve symmetry, but allows for much greater overlap on one axis. Two patterns of this nature are shown in FIGS. 7 and 8. For instance, in FIG. 7, a diagram shows a lattice with white shapes 700 that are connected in rows and cross-hatched shapes 720 are connected in columns. Note that adjacent rows of the white shapes 700 have significant overlap, while adjacent rows of the cross-hatched shapes 702 are closer together than in other designs, such as diamonds, that use the same shape on both axes. In this case, the width of the white electrodes 700 is nearly twice their pitch. The arrangement shown in a diagram, for example, in FIG. 8 has a different shape than that shown in FIG. 7, but utilizes a similar strategy with white shapes 800 overlapping with cross hatched shapes 802.

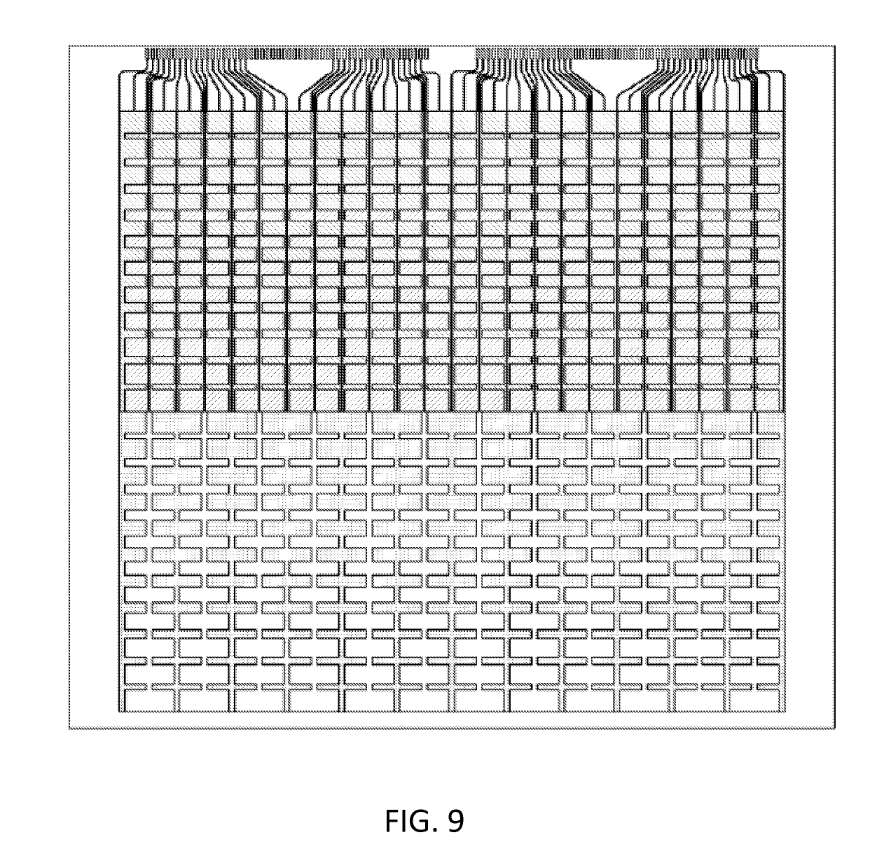

A third approach is to combine overlap on one axis with a strategy based on alternating size gradients on a second axis. An example of this approach is shown in FIG. 9 which illustrates an electrode pattern in which no electrode crosses over another electrode. This design features both a high degree of overlap (along the horizontal axis) and a varying relative size of electrodes (along the vertical axis), as strategies for providing high finger position resolution. This approach has a secondary advantage in that it does not require electrodes to pass over or under one another, and therefore, potentially may use only a single sheet of conductive material. It has the disadvantage that it does not support multitouch sensing as readily because each electrode produces only one signal. Thus, two fingers on the same line may simply appear to be one larger finger, or a difficult-to-understand signal. However, one way to improve this is to use “blocks” of overlapped and alternating electrodes, as illustrated in FIG. 9. For example, the pattern is broken into two “blocks”, one on the top half of the diagram and one on the bottom half. These blocks represent completely independent sets of electrodes. Whereas two fingers along the same vertical axis cannot be separately detected if they are on the same block, they can be if they are on separate blocks.

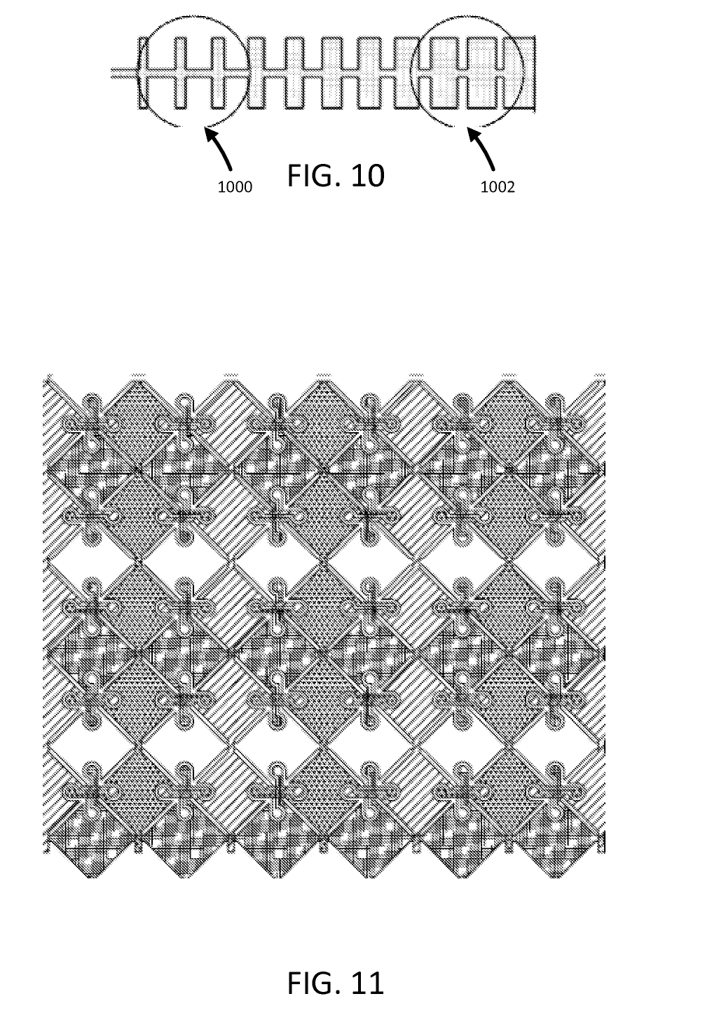

The electrodes in the diagram showing a simplified electrode pattern in FIG. 9 exhibit an areal density that is a function of the position along the length of the electrode. In other words, the intersection of a fixed-size circle 1000 (or roughly circular shape, as in the case of a fingertip contact patch) with the electrode, produces an area which is a function of the position along the length of the electrode, as illustrated in the diagram of an electrode design in FIG. 10. Thus, FIG. 10 shows an electrode design in which the areal density is a function of location along the length of the electrode. The areal density is the amount of available area occupied by the electrode, which may be estimated by finding the area of intersection with a fixed-size circle. As shown in FIG. 10, the area of overlap is greater toward the right end of the electrode 1002 than toward the left end 1000.

A fourth approach takes advantage of the use of a complete or continuous layer of insulator between each layer of electrodes. With this strategy, the only cost or disadvantage to additional intersections (i.e., one electrode passing over another) is some amount of additional capacitive coupling between electrodes. Therefore, instead of minimizing the number of intersections as conventional wisdom would suggest, more intersections can be added to help create greater overlap. This strategy is illustrated in the diagram showing a simplified view of an electrode pattern in FIG. 11. Because the x and y axes are on different levels, adjacent electrodes on each axis can have additional overlap (e.g., the circular pads shown in FIG. 11), which would have required many more bridges if manufactured with a conventional technique. As such, this strategy makes it possible to create significantly larger width than pitch.

It will be appreciated that touch interface devices and methods of constructing touch interface devices in accordance with the present disclosure may be provided in various configurations. Any variety of suitable materials of construction, configurations, shapes and sizes for the components and methods of connecting the components may be utilized to meet the particular needs and requirements of an end user. It will be apparent to those skilled in the art that various modifications can be made in the design and construction of such touch interface devices without departing from the scope or spirit of the claimed subject matter, and that the claims are not limited to the preferred embodiments illustrated herein. It also will be appreciated that the example embodiments are shown in simplified form, so as to focus on particular features and to avoid including structures that are not necessary to the disclosure and that would over complicate the drawings.

1. A haptic interface device, said device comprising:
a substrate;
a first conducting layer deposited on the substrate, with the first conducting layer being patterned to provide a first axis of individually-addressable conductive electrodes;
a first insulating layer deposited on the first conducting layer, with the insulating layer having a uniform thickness;
a second conducting layer deposited on the first insulating layer, with the second conducting layer being patterned to provide a second axis of individually-addressable conductive electrodes; and
a dielectric layer deposited on the second conducting layer, with the dielectric layer having a uniform thickness and hardness and being scratch resistant.

2. The device of claim 1, wherein the insulating layer is deposited across the entire surface of the first conductive layer such that the surface of the insulating layer is planar with no protrusions.

3. The device of claim 1, wherein the dielectric coating layer is deposited at a temperature of at least 170 C, and the substrate, the conductive layers and the insulating layer are capable of withstanding a temperature of at least 170 C without degradation.

4. The device of claim 1, wherein the dielectric layer further comprises alternating layers of organic and inorganic materials.

5. The method of claim 1, wherein the insulating layer is made of silica (SiO2).

6. The device of claim 1, wherein the dielectric layer is at least 1 micron thick.

7. The device of claim 1, wherein the dielectric layer is no more than 50 microns thick.

8. The device of claim 1, wherein the substrate, the conductive layers, the insulating layer, and the dielectric layer are transparent.

9. The device of claim 1, wherein signals for touch sensing are obtained from capacitance of each electrode, and wherein haptic effects are produced by generating an electric field between an electrode and an appendage of a user that touches a touch surface of the device.

10. The device of claim 1, wherein an index matching layer is provided underneath the first conductive layer.

11. A method of forming a haptic device, the method including the steps of:
forming a substrate;
depositing a first conductive layer on the substrate;
patterning electrodes into the first conductive layer;
depositing an insulation layer on the first conductive layer;
depositing a second conductive layer on the insulation layer;
patterning electrodes into the second conductive layers; and
depositing a dielectric layer on the second conductive layer.

12. The method of claim 11, wherein the insulating layer is deposited across the entire surface of the first conductive layer such that the surface of the insulating layer is planar with no protrusions.

13. The method of claim 11, wherein the insulating layer is made of silica (SiO2).

14. The method of claim 11, wherein the dielectric layer is deposited at a temperature of at least 170 C, and the substrate, the conductive layers and the insulating layer are capable of withstanding a temperature of at least 170 C without degradation.

15. The method of claim 11, wherein the dielectric layer further comprises alternating layers of organic and inorganic materials.

16. The method of claim 11, wherein the dielectric layer is at least 1 micron thick.

17. The method of claim 11, wherein the dielectric layer is no more than 50 microns thick.

18. The method of claim 11, wherein the substrate, the conductive layers, the insulating layer, and the dielectric layer are transparent.

19. The method of claim 11, wherein signals for touch sensing are obtained from capacitance of each electrode, and wherein haptic effects are produced by generating an electric field between an electrode and an appendage of a user that touches a touch surface of the device.

20. The method of claim 11, wherein an index matching layer is provided underneath the first conductive layer.
